(19) United States
(12) Patent Application Publication
(10) Pub. No.: US 2020/0394876 A1
(43) Pub. Date: Dec. 17, 2020

(54) A SYSTEM AND METHOD FOR PROVIDING ONLINE PULSE BETTING ON A GAME OR SPORTS EVENT

(71) Applicant: SBTech (Global) Limited, Douglas (GB)

(72) Inventors: Shalom MECKENZIE, Rishon LeZion (IL); Ian BRADLEY, Douglas (GB); Gregory KARAOLIS, Douglas (GB)

(73) Assignee: SBTech (Global) Limited, Douglas (GB)

(21) Appl. No.: 16/967,378

(22) PCT Filed: Feb. 5, 2019
(86) PCT No.: PCT/IL2019/050138

§ 371 Date: Aug. 4, 2020

Related U.S. Application Data
(60) Provisional application No. 62/626,166, filed on Feb. 5, 2018.

(51) Int. Cl. G07F 17/32

(52) U.S. Cl. CPC G07F 17/3288; G07F 17/323; G07F 17/3262; G07F 17/3213; G07F 17/3227; G07F 17/3209

(57) ABSTRACT

A system and method is provided for enabling an online user to place bets concerning incidents occurring during a game or sports event. This is done by providing a portal for a user to place a bet predicated on a defined incident occurring during a predetermined time segment of the event. The platform includes a module for calculating odds and prize returns for said incident to occur during said sports event or game in response to a user request, a GUI presentation and a settlement engine.

### BACKGROUND

Betting and gaming is a multimillion dollar international activity where online methods and systems have an increasing share of the industry.

Improvements in the industry are constantly being sought, in order to provide better opportunities for new gamblers and veterans alike. One of the long felt unmet needs in the betting industry is for a user to have the ability to closely control their activities while betting.

### SUMMARY

Embodiments of the present invention provide a system for providing online pulse betting on a game or sports event. The system comprises
a. a betting portal for a user to enter bet selections concerning defined incidents in a game occurring at predefined time segments
b. a calculation module for calculating winning amounts
c. a web application for receiving, and validating said bets
d. an incident feed
e. database for recording and storing said bet
f. a settlement engine for settling said bet

The aforementioned web application is interconnected to the incident feed for the incident, the calculation module is interconnected to the web application and is configured to calculate winning amounts in predetermined periods of the bet. The information is presented on a GUI provided with a widget, and a settlement engine comprises connectivity to the calculation module, the web application, and the widget. The settlement engine is configured to settle the bet through the aforementioned widget.

Aspects of the present invention disclose herein a betting method for enabling an online user to place bets concerning incidents occurring during a game or sports event by providing a portal for a user to place a bet. The bet is predicated on a defined incident occurring during a predetermined time segment of the game or sports event, and the method comprises the following steps:

calculating odds and prize returns for the incident to occur during the sports event or game in response to a user request offering the user betting odds by means of a display on a GUI. The GUI display comprises event title, stake amount, time segments and countdown.

The present method further enables validation steps for validating the placed bet and settling the bet by means of a settlement engine.

### BRIEF DESCRIPTION OF THE DRAWINGS

FIG. 1. is a schematic illustration of information provided to the user on the GUI of the present invention.

FIG. 2 is a schematic illustration of information provided to the user on the GUI of the present invention.

FIG. 3 is a schematic illustration of information provided to the user on the GUI of the present invention.

FIG. 4 is a schematic illustration of aspects of the system and method of the present invention.

FIG. 5 is a schematic illustration of aspects of the system and method of the present invention.

### DETAILED DESCRIPTION OF THE DRAWINGS

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. The invention is not limited by that which is illustrated in the figure and described in the specification, but only as indicated in the accompanying claims, with the proper scope determined only by the broadest interpretation of said claims.

A revolutionary new betting method is herein provided putting the user in control.

In the present invention, the user is enable to finely control the following activities:

The user can bet on demand, whenever desired during the course of the event.

The user is provided with means to control duration of their bet (duration being defined as the length of time that the user's stake is at risk).

The user is provided with means to correlate the stake with the potential returns.

It is herein acknowledged that this novel method provides methods smart pricing algorithms, to generate bet prices and thereby enables custom bet placement and settlement micro services to power the gamified betting experience in real-time.

It is a feature of the present invention that means and methods are provided for real-time settlement. It is well known that rapid settlement of bets allows the user to receive instant gratification based on the relevant incident coming from the feed.

It is a feature of the present invention that a calculation service dynamically calculates the tiered winning amounts based on the user selections It is a feature of the present invention for the web application or widget widget to run validations across prices, funds. and then call the betting microservice to confirm the bet.

It is a feature of the present invention that validations are run on the backend and a response is sent to the web application to begin running the animation showing the bet progress while asynchronously placing the bet in the database.

Characterization of the Method:

The operator defines the periods/durations and the returns per period/duration. The operator selects where the jackpot period is, early, middle or late. The winnings are not fixed unlike traditional sports betting which has a fixed stake and fixed return. “Pulse” betting has a fixed stake but variable returns, for example a “Jackpot” return in the last 10 seconds of the bet. A £1 stake, will let you win either £32, £49 or a Jackpot of £98 for the last ten seconds. It is herein acknowledged that embodiments of the present invention are applicable to spot betting as well as pulse betting.

The method of the present invention is disclosed herein: The user selects and initiates the period of the bet, for example (30 sec, 1 min, 5 min, 10 min).

The implementation algorithm of the method is configured such that the user has a fixed loss amount yet multiple winning amounts based on events and instances occurring during the period of the bet The algorithm is configured such that the winnings can be exponentially bigger than their stake.

The algorithm of the present invention is configured to provide the user with a “Jackpot” period. For example, in a soccer match, if the goal happens during the “Jackpot” period an enhanced return will be provided compared to the stake.

The aforementioned method is implemented by technologies comprising
a. Pricing algorithm
b. bet placement process module to allow bet periods to be dynamic with a GUI presenting a widget.
c. Settlement engine to be able to process the multiple winning amounts

Overall Description of the Method:

The User enters the online portal and selects an event and a stake. The user is presented on the GUI with a return on a bet for goals to happen in the period. A countdown then ensues. The user may start the bet whenever they choose throughout the period of the match.

The calculation module calculates the winning amounts based on the user selections.

The calculation module accepts or rejects the bet according to preconfigured parameters and if the bet is accepted the GUI provides information on the progress of the game, the conditions of the bet, returns on the bet and provides opportunities for the bet to be purposed to a different time segment. At the conclusion of the predetermined game or betted event, the settlement engine enables payment.

The calculation module uses inputs from incident feeds (be that just time decay or any relevant sporting incident) to dynamically calculate the probabilities of an event happening within a defined time period.

The web application of the present invention initially validates the bets on the client side before validating against the core calculations in the front.

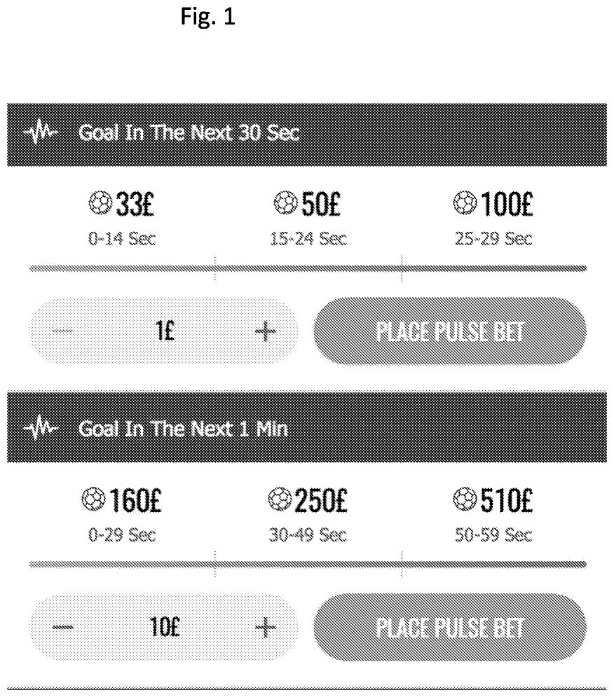

FIG. 1 is a schematic representation of the GUI showing information to the user comprising;

The bet (goal in the next 30 seconds)

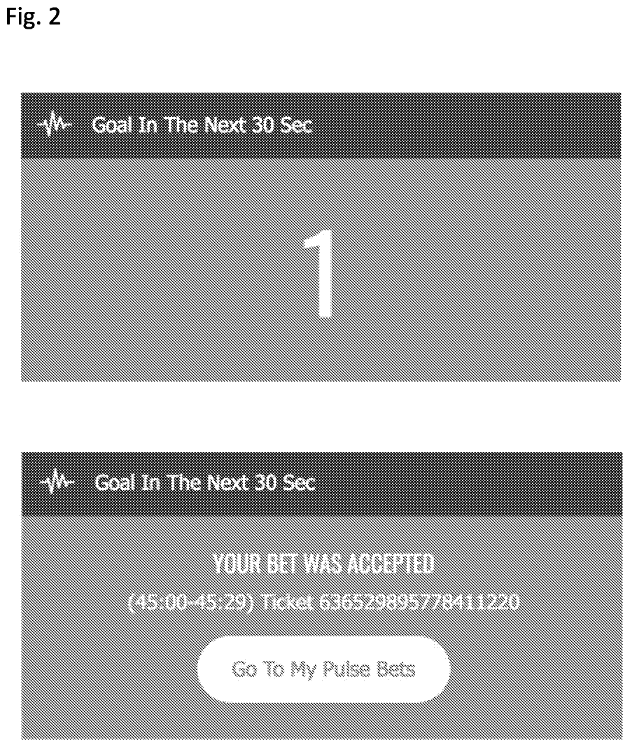

The prize: (33 GBP FIG. 2/5 if goal scored in 0-14 secs, 50 GBP if goal scored in 15-24 Secs. 100 GBP if goal scored in 25-29 Secs. etc.).

The stake (1 GBP)

FIG. 2. is a schematic representation of the GUI showing information to the user comprising the acceptance of the bet.

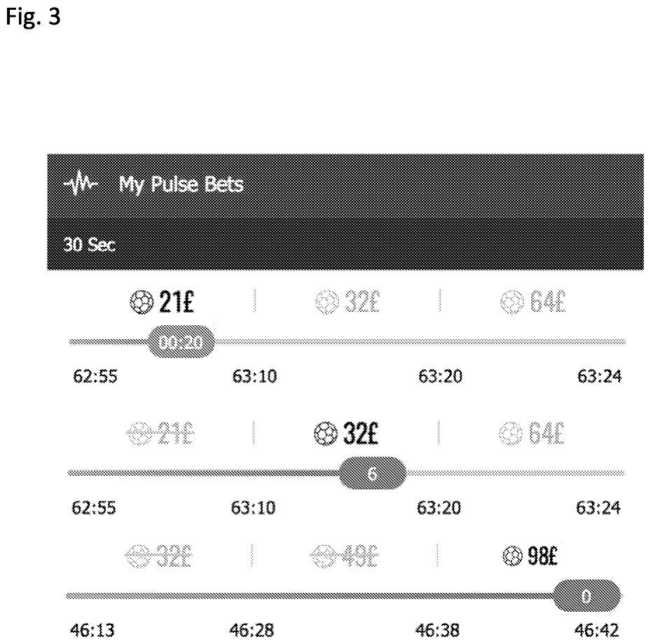

FIG. 3. is a schematic representation of the GUI showing information to the user comprising the record of the users pulse bets.

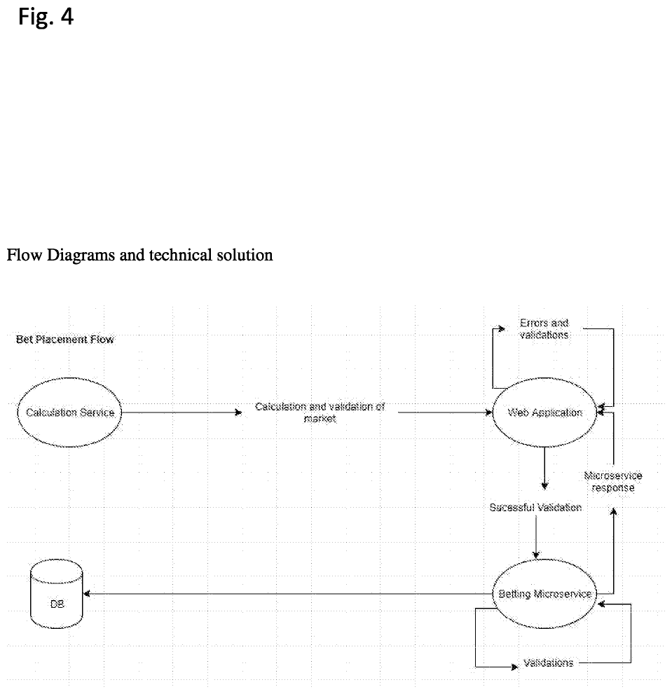

FIG. 4 is a schematic representation of the Bet Placement Flow:

A calculation service provides bet and odds calculations based on stake event and time segment data to the web application for validation. When validation has occurred the bet is lodged in the Database of the system and the GUI is activated to provide information on the bet and the bet progress.

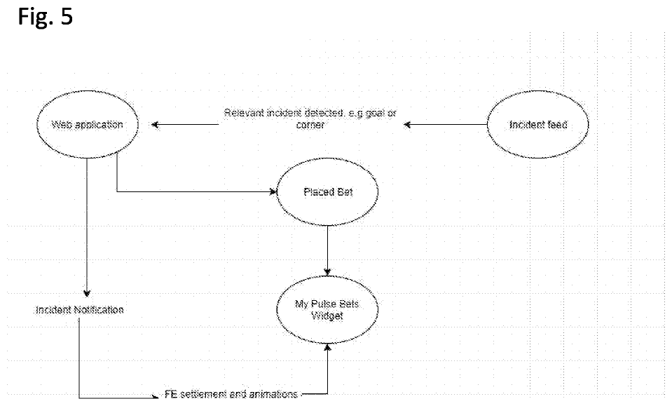

FIG. 5 is a schematic representation of the Bet Placement Flow.

The web application subscribes to SBTech incident feed.

When relevant incident messages are detected these are passed through the widget that show the bet progress so that the relevant animations are shown in the pulse bet widget Similarly the web application sends placed bet messages to the Open Pulse bets widgets as more bets are placed by users.

An incident feed is a stream of data incidents that is used for calculation and settlement purposes. For example, a goal incident would simultaneously trigger both a change in calculations as well as a settlement flow for relevant bets. The incident feeds are provided by third parties.

An incident feed provides information on the incident which is the subject of a bet (eg. goal scored in a particular time segment). Such incidents are processed through an Open Pulse Bet Widget and reported on the GUI.

1. A system for providing online pulse betting on a game or sports event comprising:
a. calculation module configured for calculating winning amounts as a function of 1) a defined incident in a game, 2) one or more predefined time segments, and 3) a fixed stake;
b. a betting portal configured for a user to enter a bet of said fixed stake concerning said defined incident occurring at a said selected predefined time segment;
c. a database, in connection with said betting portal, configured for recording and storing said bet; and
d. a web application configured for receiving said bet and initializing a validation of said bet;
e. an incident feed, configured for reporting an occurrence of said defined incident;
f. a settlement engine configured for settling said bet,
said web application is connected to said calculation engine, and further configured to present a GUI widget displaying said defined incident, said selected predefined time segment, said fixed stake, and said predefined winning amounts; and
said web application is further connected to said incident feed, and further configured to receive incident occurrences from said incident feed; and
wherein said web application is further configured to display on said GUI widget: a countdown animation upon entry of said bet; and an animation of defined incident upon receiving a report thereto from said incident feed; and
said display of said animations is performed asynchronously from said validations; and
said betting portal is provided by one or more first independent microservices and said settlement engine is provided as one or more second independent microservices;
said microservices configured to operate in real time.

2. A betting method for enabling an online user to place a bets concerning a defined incidents occurring during a game or sports event by providing a portal for a user to place a bet, of a fixed stake, predicated on a defined incident occurring during a selected predetermined time segment of said game and sports event, and carrying out steps comprising:
a. calculating odds and prize returns for said defined incident to occur during said sports event or game in response to a user request; said prize is a function of said defined incident, said selected predefined time segment, and said fixed stake;
b. offering said user said odds by means of a display on a GUI widget, said display comprising event title, said fixed stake amount, said time segments and a countdown; and
wherein said betting method further comprises steps of
c. displaying animations comprising a countdown animation upon placement of a bet on said GUI widget and a defined incident animation upon occurrence of said defined incident; and
d. asynchronously performing said displaying animations and validating said placed bet; and
e. providing one or more first independent microservices for placement of said bet and one or more second independent microservices for settling of said bet; said microservices configured to operate in real time.

3. The system of claim 1, wherein validation comprises
a. a validation of said defined incident, said fixed stakes, and said time segments, by said calculation module;
b. a validation of said bet from said betting portal;
c. a validation of bet settlement from said settlement engine, for display on said widget.

4. The system of claim 1, wherein said betting portal is further configured for the user to select said fixed stake and/or one or more of said defined incidents.

5. The system of claim 1, wherein said calculation module employs an algorithm in which winnings can be exponentially greater than said stake.

6. The system of claim 1, wherein said calculation module provides said calculations for a plurality of said settlement micro services.

7. The system of claim 1, wherein said user is provided with means to control duration of their bet (duration being defined as the length of time that the user's stake is at risk).

8. The system of claim 1, wherein said web application runs validations across prices, funds, and then calls the betting microservice to confirm the bet.

9. The method of claim 2, wherein said validating comprises steps of
a. validating said defined incident, said fixed stakes, and said time segments, by said calculation module;
b. validating said bet by said betting portal; and
c. validating bet settlement by said settlement engine, for display on said widget.

10. The method of claim 2, further comprising a step, by said user, of selecting said fixed stake and/or one or more of said defined incidents.

11. The method of claim 2, further comprising a step of employing an algorithm in which winnings can be exponentially greater than said stake.

12. The method of claim 2, further comprising a step of providing said calculation for a plurality of settlement micro services.

13. The method of claim 2, further comprising a step of providing said user with means to control duration of their bet (duration being defined as the length of time that the user's stake is at risk).

14. The method of claim 2, further comprising steps of running validations across prices and funds and then calling a betting microservice to confirm the bet.
